(19) United States
(12) Patent Application Publication
(10) Pub. No.: US 2012/0167470 A1
(43) Pub. Date: Jul. 5, 2012

(54) Pre-Hung Door Assembly

(76) Inventor: Andrew Burgess, Fall Creek, WI (US)

(21) Appl. No.: 13/335,303

(22) Filed: Dec. 22, 2011

Related U.S. Application Data
(60) Provisional application No. 61/428,377, filed on Dec. 30, 2010.

(51) Int. Cl. E06B 1/52; E06B 1/00

(52) U.S. Cl. 49/380; 49/506

(57) ABSTRACT

A pre-hung door comprises a doorframe and a door. The doorframe comprises a hinged jamb, an unhinged jamb, a sill, and a lintel. A doorstop is disposed lengthwise along one or more of the jambs. A single piece of decorative film is wrapped over both the jamb and the doorstop such that the decorative film conforms to the shape of the jamb and the doorstop. As a result, it can appear to a person that the doorstop and the jamb form a single integral piece. The door includes a particle board slab. A width of the particle board slab is approximately equal to a width of the door. The height of the particle board slab is approximately equal to a height of the door. The door does not include stiles or rails. One or more hinges attach the particle board slab to one of the jambs.

### BACKGROUND

A pre-hung door assembly comprises a prebuilt doorframe with a door already attached. Such pre-hung door assemblies are popular in the construction and renovation industries because they save the installer from the time and expense of separately crafting doorframes for individual doors. A pre-hung door assembly typically includes a door, two upright jambs, a sill, and a lintel. The jambs are parallel to one another. The sill is parallel to the lintel. When the pre-hung door assembly is installed, the sill rests on the floor and the jambs extend upward toward the ceiling. Hinges attach the door to one of the jambs.

Most doorframes of pre-hung door assemblies also include a doorstop. The doorstop is a typically a separate strip of solid wood that runs lengthwise along the jamb or lintel of the doorframe. The doorstop can serve to stop the door from swinging past the desired closed position. In addition, the doorstop can serve to prevent air and light from passing in a straight line between door and the jamb or lintel of the doorframe. Traditionally, the doorstop is attached to the jamb or lintel of the doorframe during a separate step in a manufacturing process of the pre-hung door.

The doors in pre-hung door assemblies can be hollow core doors. Hollow core doors typically include two stiles and two rails. The stiles form the vertical outside edges of the door. The stiles are aligned with the jambs. The rails form the top and bottom edges of the door. The rails are aligned with the sill and the lintel. Panels are attached to the stiles and rails, forming an interior space. The interior space of a hollow core door typically contains a lattice made of corrugated cardboard or wooden slats. Alternatively, the doors in pre-hung door assemblies can be solid core doors. Typical solid core doors have stiles and rails like hollow core doors. However, the interior space of a solid core door contains a filler material, such as insulating foam or low-density particle board.

### SUMMARY

A pre-hung door comprises a doorframe and a door. The doorframe comprises a hinged jamb, an unhinged jamb, a sill, and a lintel. A doorstop is disposed lengthwise along one or more of the jambs. A single piece of decorative film is wrapped over both the jamb and the doorstop such that the decorative film conforms to the shape of the jamb and the doorstop. As a result, it can appear to a person that the doorstop and the jamb form a single integral piece.

The door includes a particle board slab. A width of the particle board slab is approximately equal to a width of the door. The height of the particle board slab is approximately equal to a height of the door. The door does not include stiles or rails. One or more hinges attach the particle board slab to one of the jambs.

### BRIEF DESCRIPTION OF THE DRAWINGS

FIG. 1 illustrates an example pre-hung door assembly.

FIG. 2A is a profile view of an end of a first example embodiment of a jamb.

FIG. 2B is a profile view of an end of a second embodiment of a jamb.

FIG. 3 is a flowchart illustrating an example process to manufacture the pre-hung door assembly.

FIG. 4 is a flowchart illustrating another example process to manufacture the pre-hung door assembly.

FIG. 5 is an exploded view of a door.

FIG. 6 is a top view of the door.

FIG. 7 is a flowchart illustrating an example process to manufacture the door.

### DETAILED DESCRIPTION

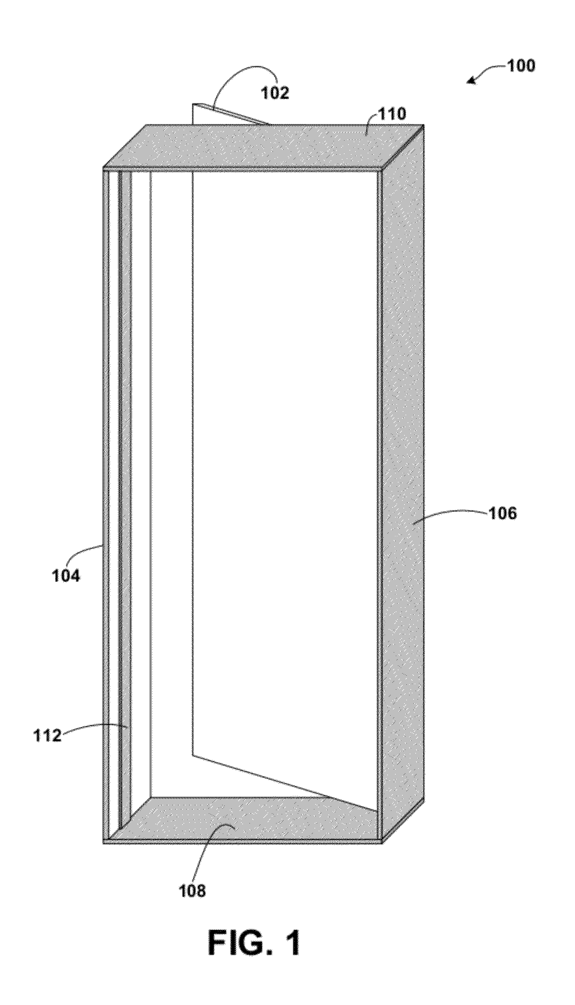

FIG. 1 illustrates an example pre-hung door assembly 100. The pre-hung door assembly comprises a door 102, an unhinged jamb 104, a hinged jamb 106, a sill 108, and a lintel 110. The unhinged jamb 104, the hinged jamb 106, the sill 108, and the lintel 110 constitute a doorframe.

As illustrated in the example of FIG. 1, a doorstop 112 is disposed lengthwise along the unhinged jamb 104. The doorstop 112 serves to stop the door 102 from swinging past a closed position. If the door 102 were to swing past the closed position, the door 102, the hinged jamb 106, and/or hinges that attach the door 102 to the hinged jamb 106 could be damaged. Furthermore, the doorstop 112 can serve to prevent air and light from passing in a straight line between the door 102 and the unhinged jamb 104. In this way, the doorstop 112 can help regulation of the climate in a room and can help preserve privacy. Although not illustrated in the example of FIG. 1 due to perspective, equivalent doorstops can be disposed lengthwise along the hinged jamb 106 and the lintel 110.

In various embodiments, the unhinged jamb 104, the hinged jamb 106, the sill 108, and the lintel 110 can be made of various materials. For example, the unhinged jamb 104, the hinged jamb 106, the sill 108 and/or the lintel 110 can be made of particle board. In another example, the unhinged jamb 104, the hinged jamb 106, the sill 108 and/or the lintel 110 can be made of solid wood. In some embodiments, the unhinged jamb 104, the hinged jamb 106, the sill 108 and/or the lintel 110 can be made of different materials. For example, the lintel 110 can be solid wood while the jambs 104 and 106 can be particle board.

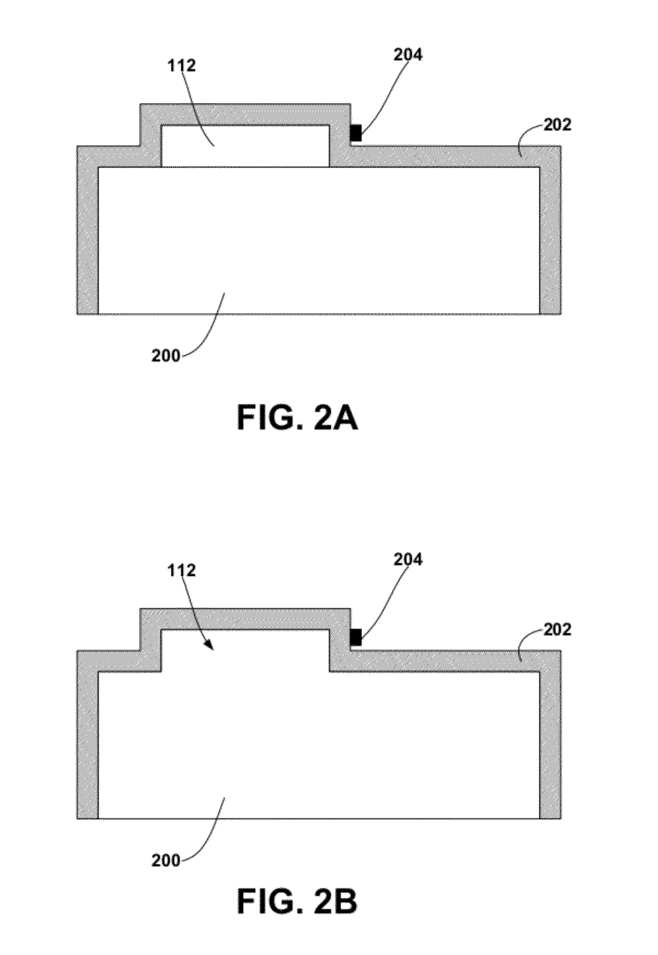

FIG. 2A is a profile view of an end of a first example embodiment of a jamb 200. The jamb 200 can be either the unhinged jamb 104 or the hinged jamb 106. The doorstop 112 is attached to the jamb 200. The jamb 200 and the doorstop 112 are generally rectangular in profile. In the example of FIG. 2A, the jamb 200 and the doorstop 112 are not a single piece. Rather, the jamb 200 and the doorstop 112 are initially separate pieces. The doorstop 112 is fastened to the jamb 200 as part of a manufacturing process. In various embodiments, the doorstop 112 is fastened to the jamb 200 in various ways. For example, the doorstop 112 can be fastened to the jamb 200 using an adhesive, nails, screws, or other fastening means.

A decorative film 202 is disposed without break over both the jamb 200 and the doorstop 112 such that the decorative film 202 conforms to the shape of the jamb 200 and the doorstop 112. Consequently, application of the decorative film 202 does not significantly change the shape of the jamb 200 and the doorstop 112. Furthermore, because the decorative film 220 is disposed without break over the jamb 200 and the doorstop 112, it can appear to a person that the doorstop 112 and the jamb 200 form a single integral piece. In various embodiments, the decorative film 202 is made of various materials. For example, the decorative film 202 can be a plastic material.

In some embodiments, the decorative film 202 has a decorative pattern for aesthetic effect. For example, the decorative film 202 can have a wood grain pattern for aesthetic effect. In another example, the decorative film 202 can have a printed water ripple pattern for aesthetic effect.

Furthermore, as illustrated in the example of FIG. 2A, a pad 204 is attached to a portion of the decorative film 202 covering an edge of the doorstop 112. The pad 204 protects the doorstop 112 from damage when the door 102 closes against the edge of the doorstop 112.

FIG. 2B is a profile view of an end of a second embodiment of the jamb 200. In the example of FIG. 2B, the jamb 200 and the doorstop 112 are a single, integrated piece. That is, the doorstop 112 does not need to be fastened to the jamb 200 as part of a manufacturing process. In other ways, the embodiment of the jamb 200 illustrated in FIG. 2B is similar to the embodiment of the jamb 200 illustrated in FIG. 2A.

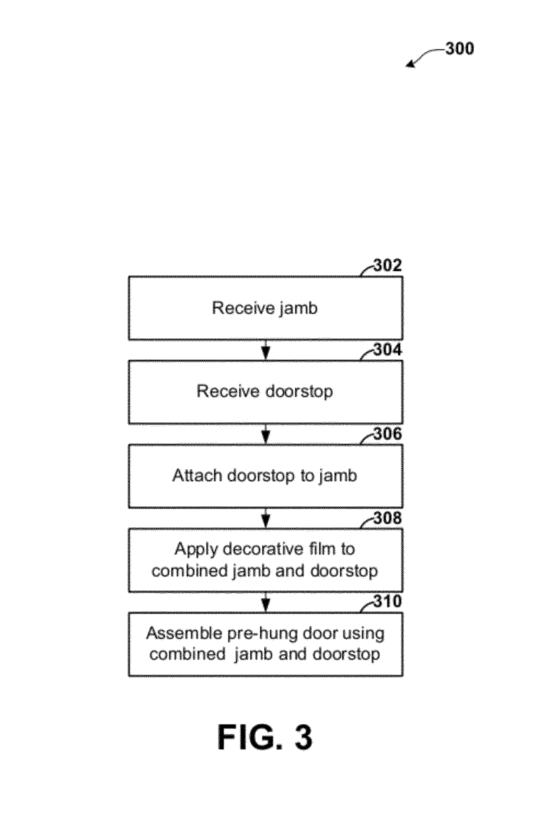

FIG. 3 is a flowchart illustrating an example process 300 to manufacture the pre-hung door assembly. As illustrated in the example of FIG. 3, the jamb 200 is received (302). In addition, the doorstop 112 is received (304). The doorstop 112 is then attached to the jamb 200 (306). In some embodiments, a person attaches the doorstop 112 to the jamb 200. In other embodiments, a machine fastens the doorstop 112 to the jamb 200. In various embodiments, various types of fasteners are used to fasten the doorstop 112 to the jamb 200. For example, nails, screws, rivets, bolts, adhesives, and other types of fasteners can be used to fasten the doorstop 112 to the jamb 200.

After the doorstop 112 is attached to the jamb 200, the decorative film 202 is applied to the combination of the jamb 200 and the doorstop 112 (308). In various embodiments, the decorative film 202 is applied to the combination of the jamb 200 and the doorstop 112 in various ways. For example, the decorative film 202 can be wound around a playout reel. As the combined jamb 200 and doorstop 112 pass through an industrial machine, the decorative film 202 plays off from the playout reel. The industrial machine applies the decorative film 202 over the combined jamb 200 and doorstop 112. The industrial machine comprises rollers or pads that press the decorative film 202 down tightly over the combined jamb 200 and doorstop 112 such that the decorative film 202 conforms to the shape of the combined jamb 200 and doorstop 112. An adhesive on the back surface (i.e., the surface facing the jamb 200 and the doorstop 112) of the decorative film 202 fastens the decorative film 202 to the jamb 200 and the doorstop 112. In some embodiments, the adhesive is on the back surface of the decorative film 202 while the decorative film 202 is on the playout reel. In other embodiments, the industrial machine adds the adhesive to the back surface of the decorative film 202 after the decorative film 202 plays off the playout reel. In this example, the decorative film 202 can already have a decorative pattern while the decorative film 202 is wound around the playout reel. Furthermore, in some instances, the playout reel can have enough of the decorative film 202 for multiple pre-hung doors.

After the decorative film 202 is applied to the jamb 200 and the doorstop 112, the pre-hung door assembly is assembled using the combination of the jamb 200, the doorstop 112, and the decorative film 202 (310). For ease of explanation, the combination of the jamb 200, the doorstop 112, and the decorative film 202 is referred to herein as the finished jamb. In various embodiments, the pre-hung door assembly is assembled using the finished jamb in various ways. For example, the finished jamb can first be fastened to the sill 108, then the lintel 110. In this example, the other jamb can then be fastened to the sill 108 and the lintel 110. In this example, the door 102 is then fastened to the other jamb. In another example, the door 102 is fastened to the finished jamb. In this example, the sill 108 and the lintel 110 are then fastened to the finished jamb. In this example, another similarly manufactured jamb is then fastened to the sill 108 and the lintel 110.

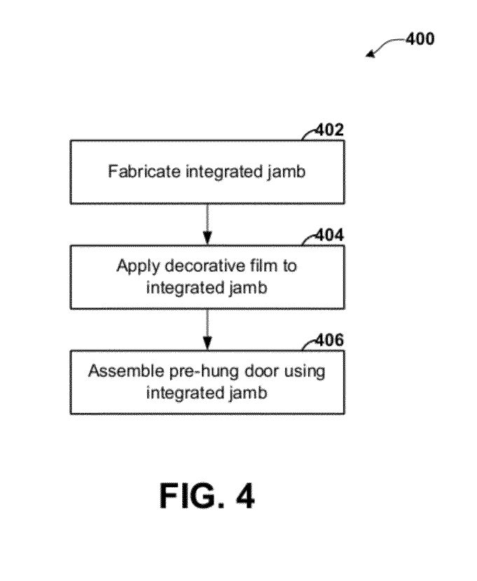

FIG. 4 is a flowchart illustrating another example process 400 to manufacture the pre-hung door assembly. As illustrated in the example of FIG. 4, the process 400 starts with fabrication of the jamb 200 with the doorstop 112 already integrated (402). For ease of explanation, the jamb 200 with the doorstop 112 already integrated is referred to herein as the integrated jamb. In various embodiments, the integrated jamb is fabricated in various ways. For example, the integrated jamb can be fabricated by cutting away portions of one side of the jamb, thereby leaving the doorstop 112 extending along the side of the jamb 200. In another example, the integrated jamb can be fabricated by pressing particle board emulsion into a mould that has the shape of the integrated jamb.

Furthermore, in some embodiments, a feedstock has the same profile and size as the integrated jamb when viewed from the ends of the feedstock and jamb. However, the feedstock can be significantly longer than the integrated jamb. The integrated jamb is fabricated by cutting crosswise through a feedstock, thereby severing the integrated jamb from the remainder of the feedstock. The remainder of the feedstock can then be used to create lintels, jambs, or other components.

In the example of FIG. 4, the decorative film 202 is applied to the integrated jamb after the integrated jamb is fabricated (404). The decorative film 202 can be applied to the integrated jamb in the manner described above with regard to FIG. 3. Alternatively, in some embodiments where fabrication of the integrated jamb involves severing the integrated jamb from a feedstock, the decorative film 202 is applied to the feedstock before the integrated jamb is severed from the feedstock.

After the decorative film 202 is applied to the integrated jamb, the pre-hung door assembly is assembled using the integrated jamb (406). The pre-hung door assembly can be assembled using the integrated jamb in a variety of ways, including those discussed above with regard to FIG. 3.

In some embodiments, a machine outputs the unhinged jamb 104, the hinged jamb 106, the sill 108, and the lintel 110 to a worker for assembly. The machine outputs the unhinged jamb 104, the hinged jamb 106, the sill 108, and the lintel 110 in an order that the worker uses the unhinged jamb 104, the hinged jamb 106, the sill 108, and the lintel 110 to assemble the pre-hung door assembly. For example, if the worker assembles the pre-hung door assembly by first attaching the unhinged jamb 104 to the lintel 110, the machine outputs the unhinged jamb 104 and the lintel 110 to the worker before outputting the hinged jamb 106 and the sill 108 to the worker. In some instances, the machine only outputs unhinged jamb 104, the hinged jamb 106, the sill 108, or the lintel 110 to the worker when the worker needs these components. For instance, the machine may output the unhinged jamb 104, the hinged jamb 106, the sill 108, or the lintel 110 in response to the worker pushing a button.

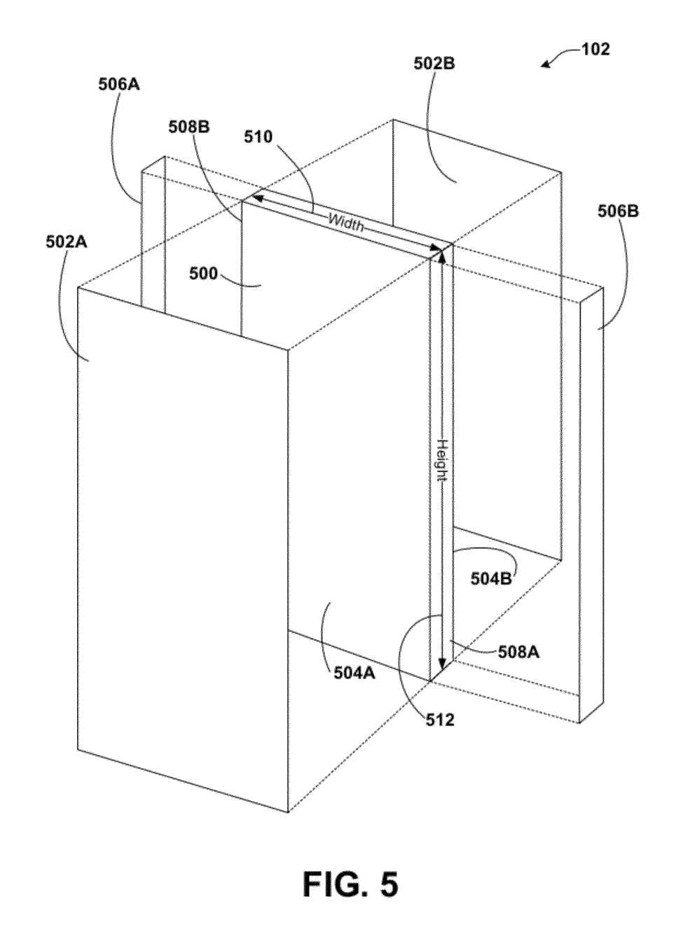

FIG. 5 is an exploded view of the door 102. It should be appreciate that the components of the door 102 are not drawn to scale or necessarily have the correct proportions to one another. As illustrated in the example of FIG. 5, the door 102 includes a particle board slab 500. The particle board slab 500 is a single piece of particle board.

In the example of FIG. 5, face panels 502A and 502B are attached to sides 504A and 504B of the particle board slab 500. This patent document can refer to the face panels 502A and 502B collectively as the face panels 502 and can refer to the sides 504A and 504B collectively as the sides 504. Edge panels 506A and 506B are attached to edge panels 508A and 508B of the particle board slab 500. This patent document can refer to the edge panels 506A and 508B collectively as the edge panels 506 and can refer to the edge panels 508A and 508B collectively as the edge panels 508. In some embodiments, the door 102 does not include the face panels 502 and/or the edge panels 506.

The face panels 502 and the edge panels 508 can serve various purposes. For example, the face panels 502 and/or the edge panels 508 can be decorative. In this example, the face panels 502 and/or the edge panels 508 can have a decorative wood grain pattern. In another example, the face panels 502 and/or the edge panels 508 can be weather-resistant. The face panels 502 and the edge panels 508 are not designed for the purpose of providing structural support to the door 102. For instance, the face panels 502 and the edge panels 508 are not a frame upon with the door 102 is built.

In various embodiments, the face panels 502 and the edge panels 506 are attached to the particle board slab 500 in various ways. For example, the face panels 502 and/or the edge panels 506 can be glued to the particle board slab 500. In another example, the face panels 502 and/or the edge panels 506 can be attached to the particle board slab 500 with fasteners, such as nails or brads.

The face panels 502 and the edge panels 506 can be made of various materials. For example, the face panels 502 and/or the edge panels 506 can be wood veneer. In another example, the face panels 502 and/or the edge panels 506 can be metal sheeting or foil. In yet another example, the face panels 502 and/or the edge panels 506 can be a plastic film. In the example of FIG. 5, the face panels 502 and the edge panels 506 are shown as being separate pieces. In other embodiments, the face panels 502 and the edge panels 506 are not necessarily separate pieces. For example, the face panels 502 and the edge panels 506 can be a single piece of film wrapped around or laminated onto the particle board slab 500.

The particle board slab 500 has a width 510 and a height 512. Excluding the widths of the edge panels 506, the width 510 of the particle board slab 500 is substantially equal to a width of the door 102. For example, the edge panels 506 can have widths of 10 millimeters, the width 510 of the particle board slab 500 can be 99.98 centimeters, and the width of the door 102 can be 1 meter. The height 512 of the particle board slab 500 can be substantially equal to a height of the door 102.

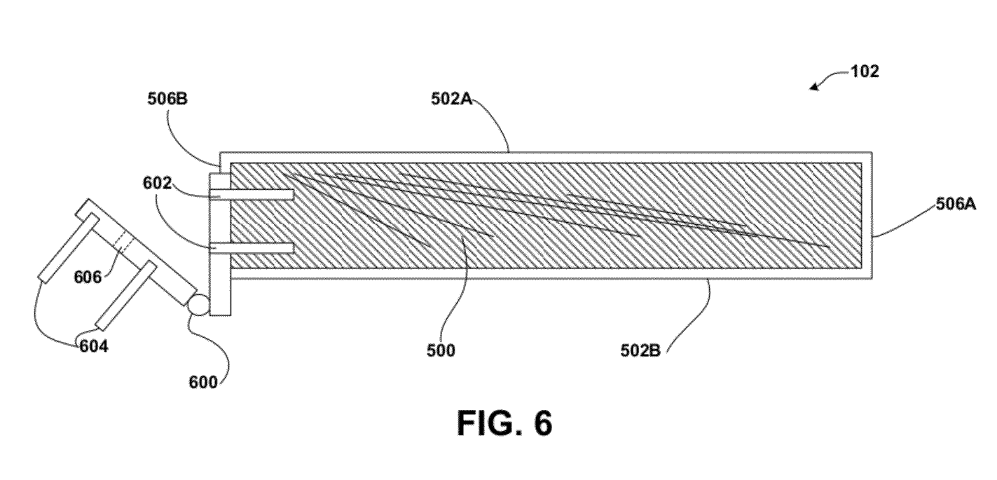

FIG. 6 is a top view of the door 102. In the example of FIG. 6, the particle board slab 500 is shown as a hatched area. As can be seen in the example of FIG. 6, a hinge 600 is attached to the door 102. Fasteners 602 extend through the hinge 600 and into the particle board slab 500. The fasteners 602 attach the hinge 600 to the door 102. The fasteners 602 grip into the particle board slab 500, thereby supporting the weight of the door 102. In various embodiments, the fasteners 602 can be various types of fasteners. For example, the fasteners 602 can be screws. In another example, the fasteners 602 can be anchor and screw assemblies. Furthermore, fasteners 604 extend through the hinge 600. The fasteners 604 can attach the hinge to the jamb 106.

Furthermore, the hinge 600 defines a hole 606. The hole 606 corresponds to a hole defined by the jamb 106. When the pre-hung door assembly 100 is installed, an installer can pass a fastener, such as a screw or bolt, through the hole 606, through the corresponding hole defined by the jamb 106, and into a stud in a wall. In this way, the fastener attaches the pre-hung door assembly 100 to the wall.

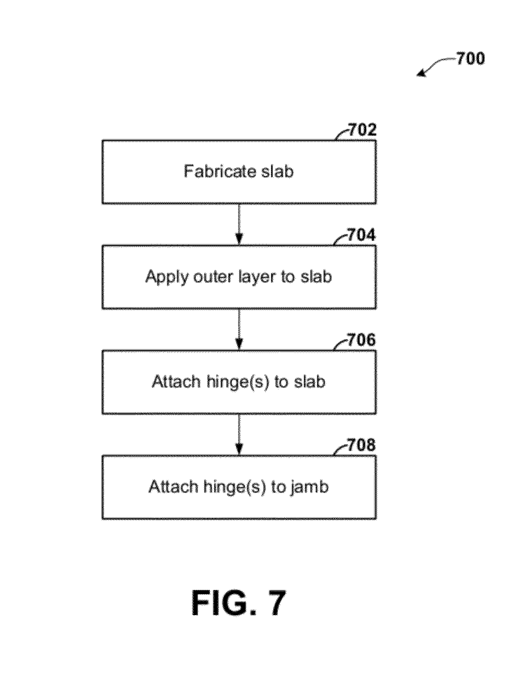

FIG. 7 is a flowchart illustrating an example process 700 to manufacture the door 102. In the example process 700, the particle board slab 500 is fabricated (702). In various embodiments, the particle board slab 500 can be fabricated in various ways. For example, in some embodiments, the particle board slab 500 can be fabricated by spraying depositing wood particles with a resin. The resulting mixture is deposited into a mold. The mixture is subsequently compressed and heated to cure the resin. In some embodiments, the mold is approximately the size of the particle board slab 500. In other embodiments, the mold is larger than the size of the particle board slab 500. In such embodiments, the resulting particle board slab is cut one or more times to form one or more particle board slabs used in doors. For instance, the mold can be 5′ by 18′. In this instance, the resulting particle board slab can be cut to form two 5′ by 9′ particle board slabs used in doors. Some or all of the particle board left over from fabricating the particle board slab 500 can be reused to fabricate other particle board slabs.

After the particle board slab 500 is fabricated, an outer layer is applied to the particle board slab 500 (704). The outer layer can surround the particle board slab 500. The outer layer can include the face panels 502 and the edge panels 506. In other embodiments, the outer layer can be a decorative film applied to the particle board slab 500.

After applying the outer layer to the particle board slab 500, one or more hinges (e.g., the hinge 600) are attached to the door 102 (706). As described above, the hinges can be attached to the door 102 using fasteners (e.g., the fasteners 602) that extend through the hinges and into the particle board slab 500. The hinges can then be attached to the jamb 106 (708). As described above, the hinges can be attached to the jamb 106 using fasteners (e.g., the fasteners 604) that extend through the hinges and into or through the jamb 106.

The process 700 can have several advantages over existing processes to manufacture doors. For example, the particle board slab 500 can be fabricated from recycled wood or mill residue. Consequently, the particle board slab 500 can have less environmental impact than doors that require boards from trees. In another example, the process 700 can be more efficient than conventional processes for manufacturing doors because the process 700 may require fewer steps. For instance, the process 700 does not require the assembly of a frame from stiles and rails. Furthermore, because particle board can be less expensive than wood or metal and because the process 700 can involve fewer steps than other processes to manufacture solid core doors, the door 102 can be less expensive than other solid core doors while still providing benefits associated with solid core doors. For instance, the door 102 can still provide the sound and temperature insulation properties of solid core doors.

The various embodiments described above are provided by way of illustration only and should not be construed as limiting. Those skilled in the art will readily recognize various modifications and changes that may be made without following the example embodiments and applications illustrated and described herein. For example, the processes shown in the figures are merely examples. In various embodiments, similar processes can include more or fewer steps than those shown in the figures. Furthermore, in other embodiments, similar processes can include the steps of the processes shown in the figures in different orders.

What is claimed is:

1. A pre-hung door assembly comprising:
a door;
a door jamb;
a doorstop coupled to the door jamb; and
a decorative film disposed over the door jamb and the doorstop, the decorative film being unbroken as the decorative film extends over the door jamb and the doorstop.

2. The pre-hung door assembly of claim 1, further comprising:
another door jamb;
a sill; and
a lintel;
wherein the door jambs, the sill, and the lintel are coupled to form a frame for the door.

3. The pre-hung door assembly of claim 1, wherein the door jamb is hinged.

4. The pre-hung door assembly of claim 1, wherein the decorative film conforms to a shape of the door jamb and the doorstop.

5. The pre-hung door assembly of claim 1, wherein the decorative film provides an appearance that the door jamb and the doorstop are an integral piece.

6. The pre-hung door assembly of claim 1, wherein the decorative film is made of plastic.

7. The pre-hung door assembly of claim 1, further comprising a pad coupled to a portion of the decorative film covering an edge of the doorstop.

8. A method for manufacturing a pre-hung door assembly, the method comprising:
receiving a door jamb;
receiving a doorstop;
attaching the doorstop to the door jamb; and
applying decorative film to the door jamb and the doorstop, the decorative film being unbroken as the decorative film extends over the door jamb and the doorstop.

9. The method of claim 8, wherein attaching the doorstop further comprise attaching the doorstop to the door jamb using a fastener.

10. The method of claim 8, wherein applying the decorative film further comprises playing the decorative film off of a playout reel.

11. The method of claim 10, further comprising passing the door jamb and the doorstop past the playout reel.

12. The method of claim 11, wherein applying the decorative film further comprising using rollers or pads to press the decorative film over the door jamb and the doorstop such that the decorative film conforms to a shape of the door jamb and the doorstop.

13. The method of claim 8, wherein applying the decorative film further comprising using rollers or pads to press the decorative film over the door jamb and the doorstop such that the decorative film conforms to a shape of the door jamb and the doorstop.

14. The method of claim 13, further comprising applying an adhesive to a back of the decorative film to adhere the decorative film to the door jamb and the doorstop.

15. The method of claim 8, further comprising coupling another door jamb, a sill, and a lintel to form a frame for the door.

16. The method of claim 8, wherein the door jamb is hinged.

17. The method of claim 8, wherein the decorative film is made of plastic.

18. The method of claim 8, further comprising attaching a pad to a portion of the decorative film covering an edge of the doorstop.

19. A method for manufacturing a pre-hung door assembly, the method comprising:
fabricating a particle board slab, wherein a width of the particle board slab is approximately equal to a width of the door, and a height of the particle board slab is approximately equal to a height of the door;
applying an outer layer to the particle board slab;
attaching a hinge to the particle board slab; and
attaching the hinge to a door jamb.

20. The method of claim 19, further comprising:
receiving a door jamb;
receiving a doorstop;
attaching the doorstop to the door jamb; and
applying decorative film to the door jamb and the doorstop.
